(19) United States
(12) Patent Application Publication
(10) Pub. No.: US 2024/0407304 A1
(43) Pub. Date: Dec. 12, 2024

(54) METHOD FOR PREPARING A PRODUCT IN A SUITABLE QUANTITY FOR LOCALIZED TREATMENT IN A PLOT OF LAND

(71) Applicant: EXEL INDUSTRIES, EPERNAY (FR)

(72) Inventors: Colin CHABALLIER, PARIS (FR); Matthieu HEMMERLE, PARIS (FR)

(73) Assignee: EXEL INDUSTRIES, EPERNAY (FR)

(21) Appl. No.: 18/556,192

(22) PCT Filed: Apr. 21, 2022
(86) PCT No.: PCT/EP2022/060604

§ 371 Date: Oct. 19, 2023

(30) Foreign Application Priority Data
Apr. 21, 2021 (FR) FR2104150

(51) Int. Cl. A01G 7/06; A01C 21/00; A01C 23/04; A01M 7/00; A01M 21/04

(52) U.S. Cl. CPC A01G 7/06; A01C 21/005; A01C 21/007; A01C 23/047; A01M 7/0089; A01M 21/043

(57) ABSTRACT

The invention relates to the field of agricultural spraying. It relates to a method for preparing a treatment product in a quantity needed for treating a plot of land using a localized spraying system. According to the invention, the method (100) comprises: a step (120) of generating a vegetation prediction map, said map being generated from an earlier vegetation map and from a plant growth model that models the growth of the plants being cultivated on the plot of land; a step (130) of generating a spray prediction map, said map being generated from the vegetation prediction map, a quantity of treatment products to be sprayed being determined for each zone of the spray prediction map; and a step (140) of determining a total quantity of treatment product, said quantity being calculated according to the quantities of treatment product to be sprayed in the various zones of the spray prediction map.

### TECHNICAL FIELD

The invention is in the field of agricultural spraying and, more specifically, localized spraying based on data captured in real time. It concerns a method for preparing a treatment product in the quantity required to treat a plot of land using a localized spraying system carried by an agricultural machine. The invention also relates to a computer program and a recording medium comprising instructions leading to the implementation of this method. Finally, it relates to a system for filling a tank of the localized spraying system comprising a data processing device configured to implement the method for preparing the treatment product.

### BACKGROUND

The purpose of the agricultural spraying is to apply various treatment products to crops with the general aim of increasing their growth, their yield and/or their quality. In particular, the treatment products can be used to weed, control diseases, insect or parasite infestation, and provide the nutrients necessary for the good growth of the crops.

A spraying system conventionally comprises a tank arranged to contain a treatment product, possibly diluted, a spray boom comprising a plurality of spray stretches each equipped with a spray nozzle, and a hydraulic circuit connecting the tank to the various spray stretches. The spray boom generally extends along an axis transverse relative to a longitudinal direction in which the agricultural machine travels over the plot of land. In particular, the hydraulic circuit may comprise a pump arranged to suck the treatment product from the tank and convey it towards the spray boom, and a pressure regulator arranged to maintain the pressure in the hydraulic circuit at a predetermined threshold pressure. Each spray nozzle is arranged to spray the treatment product over a predetermined width of the plot of land defined along the transverse axis.

With the aim of reducing the use of the treatment products, the spraying systems have been adapted to allow a localized treatment of the plots of land. By localized treatment, we mean spraying the product only on those areas of the plot of land that actually require a treatment. To this end, each spray stretch is also equipped with a dispenser arranged to assume an open position, in which a circulation of the product is possible from the tank to the corresponding spray nozzle, and a closed position, in which said circulation is blocked. The various dispensers can be controlled individually. The spraying system also comprises an image acquisition system and a control unit. The image acquisition system is mounted on the agricultural machine and comprises at least one camera arranged to acquire images of the plot of land a few seconds before the spraying system passes over it. Generally, it comprises a plurality of cameras distributed along a second axis transverse relative to the longitudinal direction, so as to cover the entire width that can be treated by the spraying system. The control unit is configured to determine effective areas to be treated using an image processing performed in real time on the images acquired by the image acquisition system, and to control each of the dispensers individually according to the effective areas to be treated.

The image processing algorithms used to identify the necessary inputs of treatment products and the precision of the spraying systems have constantly improved. The localized spraying therefore provides an effective response to the problem of the reasoned use of the treatment products according to the actual needs at the time of their application. However, the localized spraying introduces a new problem in the management of the treatment products. Since the need for the treatment product is only determined at the time of the application, or at most a few seconds before, the quantity of treatment product required for a given plot of land is not known in advance. It is therefore not possible to fill the tank of the spraying system with the right quantity for treating the plot of land. This problem is made all the more acute by the fact that many treatment products have a limited period of effectiveness once they have been prepared for spraying. In particular, the treatment products can be stored in concentrated form and diluted shortly before their use. After dilution, depending on the quality and the temperature of the diluent, typically water, the useful life of the treatment product may be limited to a few days or even a few hours. This means that a farm operator is unable to know the quantity of treatment product to prepare for treating a plot of land, and the risk of over-use of treatment products remains high.

One solution for accurately determining the quantity of treatment product to be taken on board for a localized treatment in a plot of land consists in first scanning the plot of land with the image acquisition system and identifying the areas to be treated. The quantity of treatment product required is then precisely determined. However, for obvious reasons of efficiency and cost, this solution is not feasible for relatively large plots of land and/or plots of land that are a long way from where the treatment products are stored.

Another solution would be to use a satellite image acquired shortly before the forecasted treatment of the plot of land. However, this solution is not always applicable due to the variability in the availability of the satellite images, particularly as a result of the cloud cover, and an insufficient resolution for certain types of processing.

In view of the above, the aim of the invention is to provide a solution for preparing a quantity of treatment product for a given plot of land which is in line with the actual needs of that plot of land. This solution needs to be based on data that has been acquired before the agricultural machine passes over the plot of land and that is relatively easy to access.

### SUMMARY OF THE INVENTION

The invention is based on the use of a map representing the state of a plot of land, area by area and at a given date, prior to the date on which the application of the treatment is forecasted, and a model capable of determining the new state of the plot of land at the forecasted treatment date. The forecasted treatment date may be the current date or a future date. Within a plot of land, the state of each area can be determined by the state of the cultivated plants present in that area. In this case, the map representing the plot is a vegetation map and the model allowing to estimate the new state of the plot of land at a later date is a model of the growth of the cultivated plants. The state of the different areas of a plot of land can also indicate the presence of a biotic stressor. In this case, the map representing the plot of land is a map showing the presence of the biotic stressor and the model allowing to estimate the new state of the plot of land at a later date is a model that models the evolution of the biotic stressor.

More precisely, a first object of the invention is a method for preparing a treatment product for treating a plot of land by a localized spraying system carried by an agricultural machine, the method comprising:
a step of generating a vegetation forecast map, wherein a vegetation forecast map is generated from an earlier vegetation map and from a plant growth model that models the growth of the plants being cultivated in the plot of land, the vegetation forecast map and the earlier vegetation map being a graphical representation of the plot of land at a forecasted treatment date and at a date prior to the forecasted treatment date, respectively, each map spatially dividing the plot of land into a set of vegetation areas, each vegetation area being associated with a vegetation indicator representative of a state of the cultivated plants present in said vegetation area,
a step of generating a spraying forecast map, wherein a spraying forecast map is generated from the vegetation forecast map, the spraying forecast map being a graphical representation of the plot of land spatially dividing the plot of land into a set of spraying areas, each spraying areas spatially corresponding to a vegetation area and being associated with a quantity of treatment product to be sprayed as a function of the vegetation indicator of the corresponding vegetation area, and
a step of determining a total quantity of treatment product required to treat the plot of land, wherein the total quantity of treatment product is calculated as a function of the quantities of treatment product to be sprayed of the different spraying areas.

The state of cultivated plants can be identified in particular by a growth stage, by a height of the plants, a leaf surface or a spectral distribution of the reflected radiation.

A second object of the invention is a method for preparing a treatment product for the treatment of a plot of land by a localized spraying system carried by an agricultural machine, the method comprising:
a step of generating a forecast map that forecasts the presence of a biotic stressor, wherein a biotic stressor presence forecast map is generated from an earlier map showing the presence of the biotic stressor and a model that models the growth of said biotic stressor, the biotic stressor presence forecast map and the earlier map showing the presence of the biotic stressor being a graphical representation of the plot of land at a forecasted treatment date and at a date prior to the forecasted treatment date, respectively, each map spatially dividing the plot of land into a set of biotic stressor areas, each biotic stressor area being associated with a biotic stressor indicator representative of a rate of presence and/or a rate of growth of the biotic stressor in said biotic stressor area.
a step of generating a spraying forecast map, wherein a spraying forecast map is generated from the biotic stressor presence forecast map, the spraying forecast map being a graphical representation of the plot of land spatially dividing the plot of land into a set of spraying areas, each spraying areas corresponding spatially to a biotic stressor area and being associated with a quantity of treatment product to be sprayed as a function of the biotic stressor indicator of the corresponding biotic stressor area, and
a step of determining a total quantity of treatment product required to treat the plot of land, wherein the total quantity of treatment product is calculated as a function of the quantities of treatment product to be sprayed of the different spraying areas.

A biotic stressor is defined as a living organism that harms the growth of the plants cultivated in the plot of land. A biotic stressor may be a phytopathogenic agent (e.g. a fungus, bacterium or virus), an animal biotic stressor (e.g. a predator or a parasite) or an uncultivated plant.

In a general manner, the earlier vegetation map and the earlier map showing the presence of the biotic stressor can be set at a date between 1 day and 60 days before the forecasted treatment date. Preferably, this period is between 5 days and 25 days.

The quantity of treatment product may be expressed in mass or in volume.

According to a particular embodiment, during the step of generating a forecast map that forecasts the presence of a biotic stressor, the biotic stressor presence forecast map is generated, in addition, from information relating to a rate of presence and/or a rate of growth of the biotic stressor in one or more surrounding plots of land. By taking this information into account, it is possible to anticipate the arrival and the growth of the presence of the biotic stressor when there is little or no presence of this biotic stressor in the plot of land in question.

The plant growth model and the model that models the growth of the biotic stressor can take into account, as a minimum, a time elapsed between the earlier date on which the earlier map was set and the forecasted treatment date.

According to a particular embodiment, the model used to update the vegetation map or the map showing the presence of the biotic stressor takes into account agronomic data relating to the plot of land. In particular, the plant growth model is arranged to determine a vegetation indicator in each vegetation area at a second date from a vegetation indicator in that area at a first date, prior to the second date, and agronomic data relating to said vegetation area. During the step of generating the vegetation forecast map, the plant growth model then takes the date associated with the earlier vegetation map as the first date, and the forecast treatment date as the second date. In a similar way, the model that models the growth of the biotic stressor is arranged to determine a biotic stressor indicator in each biotic stressor area at a second date from a biotic stressor indicator in this area at a first date, prior to the second date, and agronomic data relating to said biotic stressor area. During the step of generating the biotic stressor presence forecast map, the model that models the growth of the biotic stressor then considers that the first date is the date associated with the earlier map showing the presence of the biotic stressor, and the second date is the forecasted treatment date.

The agronomic data comprises, for example, meteorological data covering a period between said earlier date and said forecasted treatment date, a date of earlier tillage, physicochemical parameters of the soil, a date of sowing of the cultivated plants, data relating to an earlier application of a treatment product, and/or data relating to a crop previously cultivated on the plot of land. The meteorological data may comprise, in particular, a quantity of precipitation, a duration of sunshine, an average temperature, a number of days during which a temperature threshold has been exceeded and/or a humidity level of the air and/or of the soil. The plant growth model and the model that models the growth of the biotic stressor can take into account one or more types of agronomic data.

During the step of generating a vegetation forecast map, the vegetation forecast map may be generated from a plurality of earlier vegetation maps and from the plant growth model. The earlier vegetation maps are then a graphical representation of the plot of land at different distinct dates, prior to the forecasted treatment date. Similarly, during the step of generating a forecast map that forecasts the presence of a biotic stressor, the biotic stressor presence forecast map can be generated from a plurality of earlier maps showing the presence of the biotic stressor and from the model that models the growth of the biotic stressor. The earlier maps showing the presence of the biotic stressor are then a graphical representation of the plot of land at different distinct dates, prior to the forecasted treatment date.

Each earlier vegetation map or each earlier map showing the presence of the biotic stressor can be generated from at least one satellite image and/or from images acquired during the passage of an image acquisition system through the plot of land on the earlier date in question. Each image can be generated to determine a radiation intensity in one or more wavelength bands of the visible, ultraviolet and/or infrared spectrum.

For example, each earlier vegetation map or each earlier map showing the presence of the biotic stressor can be generated by means of a system comprising:
an optical head comprising a camera and a lighting source, the camera being arranged to generate a sequence of images of the plot of land at acquisition instants separated in pairs by a predetermined acquisition period, the lighting source being arranged to emit a beam of light in the direction of the plot of land with a variable light intensity, and, preferably,
a lighting control unit arranged to determine the luminous intensity of the light beam to be emitted by the lighting source.

In particular, the lighting control unit may be composed of a plurality of lighting control sub-units. Each lighting control sub-unit is then integrated into an optical head and is arranged to determine the luminous intensity of the light beam to be emitted by the lighting source of the respective optical head as a function of at least one image generated by the camera of the respective optical head.

In particular, such a system may implement an image processing algorithm allowing for determining whether an area requires the application of a treatment product.

According to another example, each earlier vegetation map or each earlier map showing the presence of the biotic stressor may be generated by means of a method comprising: receiving geo-referenced image data of the plot of land, from one or more image capture devices not coupled to the spraying system, the geo-referenced image data comprising a plurality of pixels and geolocation data associated with each of the pixels; analysing the spectral information of the pixels to classify the pixels corresponding, where appropriate, to the biotic stressor requiring the application of a treatment product in the field; where applicable, determining a location of the biotic stressor in the field on the basis of the geo-referencing data associated with the pixels classified as corresponding to the biotic stressor; determining cartographic data comprising the location of the biotic stressor in the field, where applicable, allowing to obtain an earlier vegetation map or an earlier map showing the presence of the biotic stressor. In particular, the image capture devices are then not coupled to the spraying system, so that the mechanism for detecting the biotic stressor is physically not coupled to the spraying system. This method can be implemented by various means. In particular, the image capture devices can be mounted on an aerial drone, a manned aircraft or one or more satellites orbiting the Earth.

According to a particular embodiment, during the step of generating a spraying forecast map, the spraying forecast map is generated from the vegetation forecast map and one or more predetermined state thresholds. Each spraying areas is then associated with a quantity of product to be sprayed as a function of the vegetation indicator for the corresponding vegetation area and the predetermined state threshold or thresholds. In particular, each spraying areas can be associated with a first quantity of product to be sprayed when the vegetation indicator of the corresponding vegetation area is below a predetermined state threshold, and with a second quantity of product to be sprayed when the vegetation indicator of the corresponding vegetation area is greater than or equal to the predetermined state threshold. The first quantity of product to be sprayed or the second quantity of product to be sprayed can be zero.

Still according to a particular embodiment, during the step of generating a spraying forecast map, the spraying forecast map is generated from the biotic stressor presence forecast map and one or more predetermined presence thresholds. Each spraying areas is then associated with a quantity of product to be sprayed as a function of the biotic stressor indicator for the corresponding biotic stressor area and the predetermined presence threshold or thresholds. In particular, each spraying areas can be associated with a first quantity of product to be sprayed when the biotic stressor indicator of the corresponding biotic stressor area is below a predetermined presence threshold, and with a second quantity of product to be sprayed when the biotic stressor indicator of the corresponding biotic stressor area is greater than or equal to the predetermined presence threshold. The first quantity of product to be sprayed or the second quantity of product to be sprayed can be zero.

According to yet another particular embodiment, the step of determining the total quantity of treatment product comprises:
a sub-step of determining a margin of estimation error, wherein a margin of estimation error is determined as a function of a reliability index associated with the plant growth model or with the model that models the growth of the biotic stressor, and
a sub-step of calculating the total quantity of treatment product, wherein the total quantity of treatment product is calculated as a function of the quantities of treatment product to be sprayed of the different spraying areas and of the margin of estimation error.

The reliability index associated with the plant growth model or the model that models the growth of the biotic stressor may depend in particular on the agronomic data taken into account by the model, and/or on the time between the date on which the earlier vegetation map or the earlier map showing the presence of the biotic stressor was set and the forecasted treatment date. During the sub-step of calculating the total quantity of treatment product, a quantity of treatment product corresponding to the margin of estimation error can be calculated and added to the quantities of treatment product to be sprayed of the different spraying areas.

According to another particular embodiment, the step of determining the total quantity of treatment product comprises:
a sub-step of determining a functional safety margin, wherein a functional safety margin is determined based on parameters of the localized spraying system and/or meteorological data at the forecasted treatment date, and
a sub-step of calculating the total quantity of treatment product, wherein the total quantity of treatment product is calculated as a function of the quantities of treatment product to be sprayed of the different spraying areas and of the functional safety margin.

The meteorological data is preferably specific to the plot of land in question. In particular, the functional safety margin may depend on the wind conditions. During the sub-step of calculating the total quantity of treatment product, a quantity of treatment product corresponding to the functional safety margin can be calculated and added to the quantities of treatment product to be sprayed of the different spraying areas.

The parameters of the localized spraying system comprise, for example, a distance between adjacent spray nozzles, a spray width corresponding to a ground width covered by each spray nozzle, a travel speed of the agricultural machine, a reliability index of the travel speed, and/or a latency in the establishment of a nominal flow rate through each spray nozzle. In particular, these parameters can be used to establish a spray duration to be applied before reaching each localized area to be treated and a spray duration to be applied after leaving each area. These additional spraying times result in an additional consumption of treatment product, which is therefore taken into account when determining the quantity of treatment product required.

The method for preparing a treatment product may further comprise a step of filling a tank of the localized spraying system with the total quantity of treatment product.

The treatment product may be a bio-stimulation product, for example a fertiliser or a product allowing to stimulate the natural defences of the cultivated plant, or a biocontrol product, for example a weedkiller, an insecticide or a fungicide.

The invention also relates to a computer program comprising instructions which, when executed by a computer, lead the computer to implement the method described above.

The invention also relates to a computer-readable recording medium comprising instructions which, when executed by a computer, lead the computer to implement the method described above.

Another object of the invention is a filling system for filling a tank of a localized spraying system carried by an agricultural machine. The filling system comprises:
a hydraulic circuit designed to removably connect a reservoir containing a treatment product to the tank of the localized spraying system,
a measuring means arranged to measure a quantity of treatment product injected into the tank, and
a data processing device configured to implement the method described above.

The filling system can be installed on or off a farm, between different plots of land.

According to a particular embodiment, the measuring means comprises a flow meter installed in the hydraulic circuit and a calculation unit receiving a flow rate information from the flow meter and calculating a quantity of treatment product by time integration.

Still according to a particular embodiment, the filling system comprises a controlled valve installed in the hydraulic circuit and a control device configured to control the controlled valve. The controlled valve is configured to assume an open position or a closed position as a function of a control signal delivered by the control device. The control device is configured to receive, on the one hand, an information relating to the total quantity of treatment product determined for the treatment of a plot of land and, on the other hand, an information relating to the quantity of treatment product injected into the tank. It is also configured to deliver a signal controlling the closure of the controlled valve when the quantity of treatment product injected into the tank reaches the total quantity of treatment product.

### BRIEF DESCRIPTION OF THE DRAWINGS

Other characteristics, details and advantages of the invention will become apparent from the following description, which is given by way of example only and refers to the appended drawings in which:

FIG. 1 represents an example of a method for preparing a treatment product according to the invention.

FIG. 2 represents an example of a step of determining a total quantity of treatment product implemented in the method of FIG. 1.

### DETAILED DESCRIPTION

The aim of the invention is to estimate the quantity of treatment product required for a given treatment of a plot of land by a localized spraying system. The treatment product may be of direct benefit to the cultivated plants or have an impact on its environment. It may be a bio-stimulation product, for example a fertiliser or a product allowing to stimulate the natural defences of the cultivated plant, or a biocontrol product, for example a weedkiller to treat the uncultivated plants, an insecticide or a fungicide. The localized spraying system comprises a tank arranged to contain at least one treatment product, a spray boom comprising a plurality of spray stretches and a hydraulic circuit connecting the tank to the various spray stretches. The hydraulic circuit can comprise a pump arranged to suck treatment product from the tank and convey it to the spray boom. It may also comprise a pressure regulator arranged to maintain the pressure in the hydraulic circuit at a predetermined threshold pressure.

The localized spraying involves a prior diagnostic step consisting of determining, for each elementary area of the plot of land, whether or not an application of treatment product is necessary. This determination is at least qualitative and may be quantitative. It is generally performed by analysing images acquired by an image acquisition system comprising a plurality of cameras usually mounted on the front of an agricultural machine. The cameras can be mounted on a ramp extending transversely relative to a longitudinal direction in which the agricultural machine travels over the plot of land, so as to cover a width extending over several metres. The analysis of the images can be based on various image processing algorithms. In particular, it can analyse the shape of the plants and their electromagnetic spectrum. The differentiated application of the treatment to the different elementary areas is ensured by the plurality of spray stretches, each comprising a spray nozzle and a dispenser. The spray boom also extends transversely relative to the longitudinal direction of travel of the agricultural machine. It is located behind the ramp carrying the cameras, so as to allow the images to be processed before the spray boom passes. The image processing is referred to as real-time processing. In practice, it can last up to a few seconds. Each spray nozzle is arranged to spray the treatment product over a predetermined width of the plot of land defined along the transverse axis. Each dispenser is arranged to assume an open position, in which a circulation of the product is possible from the tank to the corresponding spray nozzle, and a closed position, in which said circulation is blocked. The dispensers are controlled individually by a control unit. They, are controlled in the open position when the corresponding spray nozzle passes over an elementary area to be treated, and in the closed position otherwise.

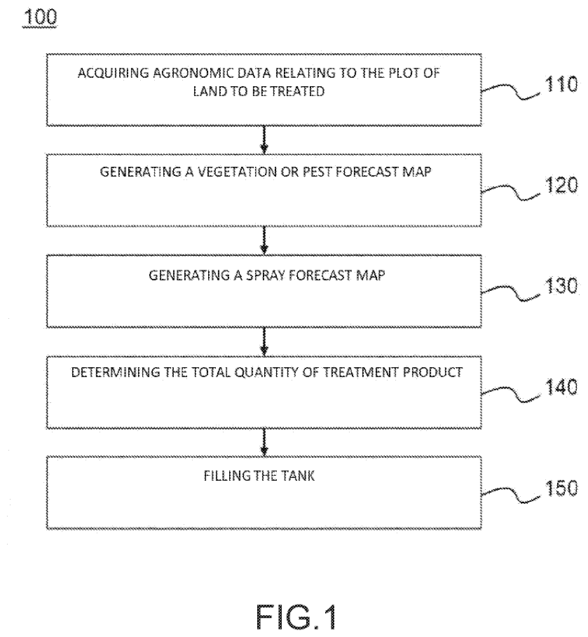

FIG. 1 represents an example of a method for preparing a treatment product according to the invention. The method 100 comprises a step 110 of acquiring agronomic data relating to the plot of land to be treated, a step 120 of generating a vegetation forecast map and/or a forecast map that forecasts the presence of a biotic stressor, a step 130 of generating a spraying forecast map, a step 140 of determining the total quantity of treatment product and a step 150 of filling the tank.

The method according to the invention is based on the use of a vegetation map or a map showing the presence of a biotic stressor. A vegetation map spatially divides the plot of land into a set of areas, referred to as “vegetation areas”, each area being associated with a vegetation indicator representative of a state of the cultivated plants present in said vegetation area. The state of the cultivated plants can be identified in particular by a growth stage, by a height of the plants, a leaf surface or a spectral distribution of the reflected radiation. The vegetation map therefore comprises data relating to a spatial distribution of the state of the plants on the plot of land. This data is typically obtained from satellite images or from images acquired during a previous passage through the plot of land by the image acquisition system. This passage may have been performed a few days or a few weeks before the forecasted treatment date. The vegetation map is then referred to as the “earlier vegetation map” and the date on which the images were acquired is referred to as the “earlier date”.

Similarly, a map showing the presence of a biotic stressor spatially divides the plot of land into a set of areas, referred to as “biotic stressor areas”, each area being associated with a biotic stressor indicator representative of a rate of presence and/or a rate of growth of the biotic stressor in said biotic stressor area. This data is generally obtained from images acquired during an earlier passage through the plot of land by the image acquisition system. This passage may have been performed a few days or a few weeks before the forecasted treatment date. The map showing the presence of the biotic stressor is then referred to as the “earlier map showing the presence of the biotic stressor” and the date on which the images were acquired is referred to as the “earlier date”.

Step 110 of acquiring agronomic data relating to the plot of land to be treated consists in collecting information relating to one or more parameters likely to influence the growth of the cultivated plants or the growth of a biotic stressor. The agronomic data advantageously relates to the period between the earlier date and the date on which the treatment is forecasted to be applied, referred to as the “forecasted treatment date”. This information can be global for the set of the plot of land or localized. i.e., it can vary according to areas within the plot of land. Global agronomic data may comprise a date of earlier tillage of the plot of land, a date of sowing of the cultivated plants, data relating to an earlier application of a treatment product, data relating to a crop previously cultivated on the plot of land and/or meteorological data. The meteorological data comprises, for example, a quantity of precipitation, a duration of sunshine, an average temperature, a number of days during which a temperature threshold has been exceeded and/or a humidity level of the air and/or of the soil. Localized agronomic data concerns, for example, the physico-chemical parameters of the soil. i.e., the composition of the soil.

Step 120 of generating a vegetation forecast map or a forecast map that forecasts the presence of a biotic stressor consists in updating the earlier vegetation map or the earlier map showing the presence of the biotic stressor as a function, respectively, of a plant growth model or a model that models the evolution of the biotic stressor, and of the agronomic data acquired in step 110. The map is updated so as to reflect the state of the plot of land on the forecasted treatment date. It is referred to as a “vegetation forecast map” or “biotic stressor presence forecast map”. During the step of generating the vegetation forecast map, for each vegetation area, the vegetation indicator at the earlier date and the agronomic data are fed into the plant growth model, which generates an output vegetation indicator at the forecasted treatment date. In a similar way, during the step of generating the biotic stressor presence forecast map, for each biotic stressor area, the biotic stress indicator at the earlier date and the agronomic data are injected into the evolution model that models the evolution of the biotic stressor, which generates an output biotic stressor indicator at the forecasted treatment date. The plant growth model and the evolution model of the biotic stressor can take into account a single type of agronomic data or several types of agronomic data.

Step 130 of generating a spraying forecast map consists in generating a spraying forecast map from the vegetation forecast map or from the biotic stressor presence forecast map. The spraying forecast map is a graphical representation of the plot of land in question, spatially dividing the plot of land into different areas, referred to as “spraying areas”. Each spraying areas corresponds spatially to a vegetation area or a biotic stressor area and is associated with a quantity of treatment product to be sprayed. Said quantity is determined, for each area, as a function of the vegetation indicator for the corresponding vegetation area or of the biotic stressor indicator for the corresponding biotic stressor area.

According to a particular embodiment, the spraying forecast map is generated from the vegetation forecast map and a predetermined state threshold. When, in a vegetation area, the vegetation indicator has a value below the predetermined state threshold, the corresponding spraying areas can be associated with a first quantity of product to be sprayed. On the other hand, when, in a vegetation area, the vegetation indicator has a value greater than or equal to the predetermined state threshold, the corresponding spraying areas can be associated with a second quantity of product to be sprayed. For example, when the vegetation indicator is representative of a relatively early state of growth, a quantity of product in accordance with the recommendations of the manufacturer of the treatment product may be associated with the corresponding spraying areas; and, when the vegetation indicator is representative of a relatively late state of growth, a quantity of product of zero may be associated with the corresponding spraying areas.

According to another particular embodiment, the spraying forecast map is generated from the biotic stressor presence forecast map and of a predetermined presence threshold. When, in a biotic stressor area, the biotic stressor indicator has a value below the predetermined presence threshold, the corresponding spraying areas can be associated with a first quantity of product to be sprayed. On the other hand, when, in a biotic stressor area, the biotic stressor indicator has a value greater than or equal to the predetermined presence threshold, the corresponding spraying areas can be associated with a second quantity of product to be sprayed. For example, when the biotic stressor indicator is representative of a relatively low presence of insect biotic stressors, a zero quantity of product may be associated with the corresponding spraying areas; and, when the biotic stressor indicator is representative of a relatively high presence of insect biotic stressors, a quantity of product in accordance with the recommendations of the manufacturer of the treatment product may be associated with the corresponding spraying areas.

The step 140 of determining the total quantity of treatment product consists in determining the total quantity of treatment product, necessary for the localized treatment of the plot of land, as a function of the quantities of treatment product of the different spraying areas of the spraying forecast map. In a particular embodiment, the total quantity of treatment product is determined as the sum of the quantities of treatment product for the set of the spraying areas on the spraying forecast map.

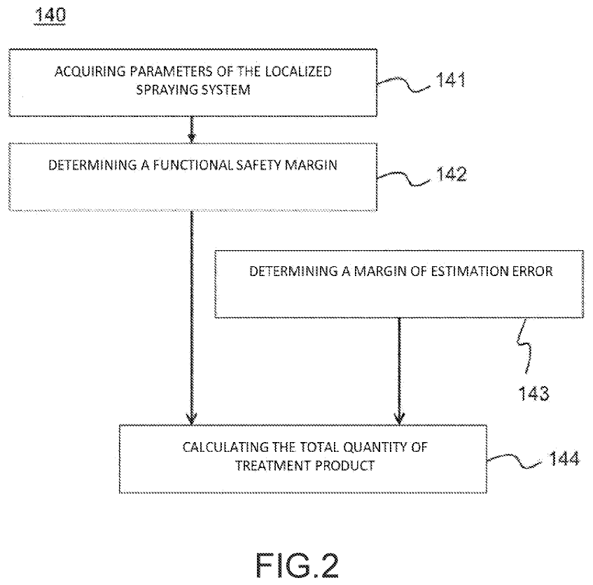

FIG. 2 represents another particular embodiment of step 140 for determining the total quantity of treatment product. Step 140 comprises a sub-step 141 for acquiring parameters of the localized spraying system, a sub-step 142 of determining a functional safety margin, a sub-step 143 of determining a margin of estimation error and a sub-step 144 of calculating the total quantity of treatment product.

The sub-step 141 of acquiring parameters of the spraying system consists in acquiring parameters relating to the arrangement and/or to the properties of the spraying system. These parameters comprise, for example, a distance between the spray nozzles of the different adjacent spray stretches along the axis of the spray arm, a spray width, a travel speed of the agricultural machine and therefore of the spraying system, a reliability index of the travel speed, and/or a latency in establishing a nominal flow rate through each spray nozzle.

The sub-step 142 of determining a functional safety margin consists in estimating the additional quantity of treatment product required due to uncertainties associated with the physical parameters of the spraying system and/or with the meteorological conditions during the spraying of the treatment product. In particular, in the presence of wind, it may be decided to apply more treatment product upstream and downstream of each elementary area to be treated. The additional quantity of treatment product, referred to as the “functional safety margin”, is determined, for example, by calculating a spray time to be applied before reaching each elementary area to be treated and a spray time to be applied after leaving each area. Based on the estimated number of areas to be treated and on the flow rate of each spray nozzle, it is then possible to calculate the functional safety margin.

The sub-step 143 of determining a margin of estimation error is intended to quantify the maximum difference likely to be observed between the total quantity of treatment product estimated by the method and the quantity of treatment product which will actually be used to treat the plot of land. This involves determining an additional quantity of treatment product, referred to as the “margin of estimation error”, based on a reliability index associated with the plant growth model or with the evolution model of the biotic stressor used. This index may vary depending on the agronomic data used by the model and/or on the time between the earlier date on which the earlier vegetation map was set and the forecasted treatment date.

The sub-step 144 of calculating the total quantity of treatment product consists in calculating the total quantity of treatment product as a function of the quantities of treatment product in the different spraying areas of the spraying forecast map, the functional safety margin and the estimation error margin. In practice, the total quantity of treatment product can be calculated by adding together the quantities of treatment product for the set of the spraying areas in the spraying forecast map, the functional safety margin and the estimation error margin.

The calculation step 140 may not comprise the sub-step 141 of acquiring parameters of the localized spraying system and the sub-step 142 of determining a functional safety margin, or the sub-step 143 of determining a margin of estimation error. The sub-step 144 of calculating the total quantity of treatment product then only takes into account the functional safety margin or the estimation error margin. It should also be noted that the sub-step 143 of determining a margin of estimation error can be carried out before, during or after the parameter acquisition sub-step 141 and the sub-step 142 of determining a functional safety margin.

When the treatment product is to be applied in diluted form, the step 140 of determining the total quantity of treatment product may also comprise a sub-step of determining a quantity of diluent to be used with the total quantity of treatment product. The quantity of diluent should preferably be determined according to the recommendations of the supplier of the treatment product. The diluent is water, for example.

Reference is again made to FIG. 1. The step 150 of filling the tank consists in filling the tank of the localized spraying system with the total quantity of treatment product and, if necessary, the quantity of diluent, determined in step 140. In the latter case, the filling step 150 may comprise a sub-step of mixing the treatment product with the diluent. This sub-step may be carried out directly in the tank of the localized spraying system, or upstream.

The filling step 150 may be carried out using a filling system of an agricultural installation. The filling system may comprise one or more storage reservoirs, a hydraulic circuit and a measuring means. Each storage reservoir can contain a treatment product and be associated with a manual or controlled valve allowing to control the flowing of the treatment product in the hydraulic circuit. The hydraulic circuit is arranged to removably connect each reservoir to the tank of the spraying system. The measuring means is arranged to measure a quantity of treatment product injected into the tank. In particular, it may comprise a flow meter installed in the hydraulic circuit and a calculation unit receiving a flow rate information from the flow meter and calculating the quantity of treatment product tipped out by time integration.

The filling system may also comprise a control device configured to control the controlled valve as a function of information relating to the quantity of treatment product measured by the measuring means and an information relating to the total quantity of treatment product determined in step 140. In this case, the control device can be configured to close the controlled valve when the measured quantity of treatment product reaches the total quantity of treatment product.

In addition, the filling system may comprise a data processing device arranged to implement the other steps 110, 120, 130, 140 of the method 100 according to the invention. In particular, the device may comprise a user interface allowing to enter the agronomic data and the parameters of the localized spraying system, in accordance with steps 110 and 141. It may also comprise a processor arranged to implement the step 120 of generating a vegetation forecast map and/or a forecast map that forecasts the presence of a biotic stressor, the step 130 of generating a spraying forecast map and the step 140 of determining the total quantity of treatment product. In a particular embodiment, the computing unit of the measuring means and/or the control device associated with the controlled valve are integrated into the data processing device.

1-15. (canceled)

16. A method for preparing a treatment product for treating a plot of land by a localized spraying system carried by an agricultural machine, the method comprising:
a step of generating a vegetation forecast map, wherein a vegetation forecast map is generated from an earlier vegetation map and from a plant growth model that models the growth of the plants being cultivated in the plot of land, the vegetation forecast map and the earlier vegetation map being a graphical representation of the plot of land at a forecasted treatment date and at a date prior to the forecasted treatment date, respectively, each map spatially dividing the plot of land into a set of vegetation areas, each vegetation area being associated with a vegetation indicator representative of a state for the cultivated plants present in said vegetation area,
a step of generating a spraying forecast map, wherein a spraying forecast map is generated from the vegetation forecast map, the spraying forecast map being a graphical representation of the plot of land spatially dividing the plot of land into a set of spraying areas, each spraying area spatially corresponding to a vegetation area and being associated with a quantity of treatment product to be sprayed as a function of the vegetation indicator of the corresponding vegetation area, and
a step of determining a total quantity of treatment product required to treat the plot of land, wherein the total quantity of treatment product is calculated as a function of the quantities of treatment product to be sprayed of the different spraying areas.

17. A method for preparing a treatment product for treating a plot of land by a localized spraying system carried by an agricultural machine, the method comprising:
a step of generating a biotic stressor presence forecast map, wherein a biotic stressor presence forecast map is generated from an earlier map showing the presence of the biotic stressor and from an evolution biotic stressor model that models the evolution of said biotic stressor, the biotic stressor presence forecast map that biotic stressor and the earlier map showing the presence of the biotic stressor being a graphical representation of the plot of land at a forecasted treatment date and at a date prior to the forecasted treatment date, respectively, each map spatially dividing the plot of land into a set of biotic stress areas, each biotic stress area being associated with a biotic stress indicator representative of a rate of presence and/or a rate of the biotic stressor growth biotic stressor in said biotic stress area,
a step of generating a spraying forecast map, wherein a spraying forecast map is generated from the biotic stressor presence forecast map, the spraying forecast map being a graphical representation of the plot of land spatially dividing the plot of land into a set of spraying areas, each spraying areas corresponding spatially to a biotic stress area and being associated with a quantity of treatment product to be sprayed as a function of the biotic stress indicator of the corresponding biotic stress area, and
a step of determining a total quantity of treatment product required to treat the plot of land, wherein the total quantity of treatment product is calculated as a function of the quantities of treatment product to be sprayed of the different spraying areas.

18. The method according to claim 17, wherein, during the step of generating a biotic stressor presence forecast map, the biotic stressor presence forecast map biotic stressor is generated, in addition, from information relating to a rate of presence and/or a rate of the biotic stressor growth biotic stressor in one or more surrounding plots of land.

19. The method according to claim 16, wherein the plant growth model is arranged to determine a vegetation indicator in each vegetation area at a second date from a vegetation indicator in that area at a first date, prior to the second date, and agronomic data relating to said vegetation area, or in which the biotic stressor evolution model is arranged to determine a biotic stress indicator in each biotic stress area at a second date from a biotic stress indicator in this area at a first date, prior to the second date, and agronomic data relating to said biotic stress area.

20. The method according to claim 17, wherein the plant growth model is arranged to determine a vegetation indicator in each vegetation area at a second date from a vegetation indicator in that area at a first date, prior to the second date, and agronomic data relating to said vegetation area, or in which the biotic stressor evolution model is arranged to determine a biotic stress indicator in each biotic stress area at a second date from a biotic stress indicator in this area at a first date, prior to the second date, and agronomic data relating to said biotic stress area.

21. The method according to claim 19, wherein the agronomic data comprises meteorological data covering a period between said earlier date and said forecasted treatment date, a date of earlier tillage, physicochemical parameters of the soil, a date of sowing of the cultivated plants, data relating to an earlier application of a treatment product, and/or data relating to a crop previously cultivated on the plot of land.

22. The method according to claim 16, wherein, during the step of generating a vegetation forecast map, the vegetation forecast map is generated from a plurality of earlier vegetation maps and from the plant growth model, the earlier vegetation maps being a graphical representation of the plot of land at different distinct dates prior to the forecasted treatment date, or wherein, during the step of generating a biotic stressor presence forecast map, the biotic stressor presence forecast map is generated from a plurality of earlier maps showing the presence of the biotic stressor and from the evolution model that models the evolution of the biotic stressor, the earlier maps showing the presence of the biotic stressor being a graphical representation of the plot of land at different distinct dates, prior to the forecasted treatment date.

23. The method according to claim 17, wherein, during the step of generating a vegetation forecast map, the vegetation forecast map is generated from a plurality of earlier vegetation maps and from the plant growth model, the earlier vegetation maps being a graphical representation of the plot of land at different distinct dates prior to the forecasted treatment date, or wherein, during the step of generating a biotic stressor presence forecast map, the biotic stressor presence forecast map is generated from a plurality of earlier maps showing the presence of the biotic stressor and from the evolution model that models the evolution of the biotic stressor, the earlier maps showing the presence of the biotic stressor being a graphical representation of the plot of land at different distinct dates, prior to the forecasted treatment date.

24. The method according to claim 16, wherein each earlier vegetation map or each earlier map showing the presence of the biotic stressor is generated from at least one satellite image and/or from images acquired during a passage of an image acquisition system through the plot of land on the earlier date in question.

25. The method according to claim 17, wherein each earlier vegetation map or each earlier map showing the presence of the biotic stressor is generated from at least one satellite image and/or from images acquired during a passage of an image acquisition system through the plot of land on the earlier date in question.

26. The method according to claim 16, wherein the step of determining the total quantity of treatment product comprises:
a sub-step of determining a margin of estimation error, wherein a margin of estimation error is determined as a function of a reliability index associated with the plant growth model or with the biotic stressor evolution model, and
a sub-step of calculating the total quantity of treatment product, wherein the total quantity of treatment product is calculated as a function of the quantities of treatment product to be sprayed of the different spraying areas and of the margin of estimation error.

27. The method according to claim 17, wherein the step of determining the total quantity of treatment product comprises:
a sub-step of determining a margin of estimation error, wherein a margin of estimation error is determined as a function of a reliability index associated with the plant growth model or with the biotic stressor evolution model, and
a sub-step of calculating the total quantity of treatment product, wherein the total quantity of treatment product is calculated as a function of the quantities of treatment product to be sprayed of the different spraying areas and of the margin of estimation error.

28. The method according to claim 16, wherein the step of determining the total quantity of treatment product comprises:
a sub-step of determining a functional safety margin, wherein a functional safety margin is determined based on parameters of the localized spraying system and/or meteorological data at the forecasted treatment date, and
a sub-step of calculating the total quantity of treatment product, wherein the total quantity of treatment product is calculated as a function of the quantities of treatment product to be sprayed of the different spraying areas and of the functional safety margin.

29. The method according to claim 17, wherein the step of determining the total quantity of treatment product comprises:
a sub-step of determining a functional safety margin, wherein a functional safety margin is determined based on parameters of the localized spraying system and/or meteorological data at the forecasted treatment date, and
a sub-step of calculating the total quantity of treatment product, wherein the total quantity of treatment product is calculated as a function of the quantities of treatment product to be sprayed of the different spraying areas and of the functional safety margin.

30. The method of claim 28, wherein the parameters of the localized spraying system comprise a distance between adjacent spray nozzles, a spray width corresponding to a ground width covered by each spray nozzle, a travel speed of the agricultural machine, a reliability index of the travel speed, and/or a latency in the establishment of a nominal flow rate through each spray nozzle.

31. The method according to claim 16, further comprising a step of filling a tank of the localized spraying system with the total quantity of treatment product.

32. The method according to claim 17, further comprising a step of filling a tank of the localized spraying system with the total quantity of treatment product.

33. The method according to claim 16, wherein the treatment product is a bio-stimulation product or a biocontrol product.

34. The method according to claim 17, wherein the treatment product is a bio-stimulation product or a biocontrol product.

35. A computer program comprising instructions which, when executed by a computer, lead the computer to implement the method of claim 16.

36. A computer program comprising instructions which, when executed by a computer, lead the computer to implement the method of claim 17.

37. A computer-readable recording medium comprising instructions which, when executed by a computer, lead the computer to implement the method of claim 16.

38. A filling system for filling a tank of a localized spraying system carried by an agricultural machine, the filling system comprising:
a hydraulic circuit designed to removably connect a reservoir containing a treatment product to the tank of the localized spraying system,
a measuring means arranged to measure a quantity of treatment product injected into the tank, and
a data processing device configured to implement the method according to claim 16.

39. A filling system for filling a tank of a localized spraying system carried by an agricultural machine, the filling system comprising:
a hydraulic circuit designed to removably connect a reservoir containing a treatment product to the tank of the localized spraying system,
a measuring means arranged to measure a quantity of treatment product injected into the tank, and
a data processing device configured to implement the method according to claim 17.
